(19) United States
(12) Patent Application Publication
(10) Pub. No.: US 2013/0241346 A1
(43) Pub. Date: Sep. 19, 2013

(54) DEVICE FOR CONVERTING MECHANICAL ENERGY INTO ELECTRICAL ENERGY

(71) Applicants: Sebastien Boisseau, Grenoble (FR); Ghislain Despesse, Voreppe (FR)

(72) Inventors: Sebastien Boisseau, Grenoble (FR); Ghislain Despesse, Voreppe (FR)

(73) Assignee: COMMISSARIATÀ L'ÉNERGIE ATOMIQUE ET AUX ÉNERGIES ALTERNATIVES, Paris (FR)

(21) Appl. No.: 13/989,885

(22) PCT Filed: Nov. 28, 2011
(86) PCT No.: PCT/EP2011/071194

§ 371 Date: May 28, 2013

(30) Foreign Application Priority Data
Nov. 29, 2010 (FR) 1059842

(51) Int. Cl. H02N 1/00

(52) U.S. Cl. CPC H02N 1/002
USPC 310/300; 29/886

(57) ABSTRACT

An apparatus for converting mechanical vibrational energy into electrical power includes first and second collecting electrodes configured for connection to terminals of an electrical load, and an electret placed facing the first electrode. The electret is mounted so as to move relative to the first electrode in one degree-of-freedom in a plane. Relative movement between the electret and the first electrode induces a potential difference across the electrodes. The electret has a continuous layer and a series of protrusions, each of which extends perpendicular to the plane. These protrusions are distributed in the degree-of-freedom with a first pitch, which is smaller than the travel between the first electrode and the electret. The first electrode has faces facing the electret. These faces are distributed in the degree-of-freedom with a second pitch identical to the first pitch.

The invention relates to devices for converting mechanical energy into electrical power, and in particular to standalone power-supply devices that generate electrical power from a vibrational movement.

In certain environments, it may be difficult to connect an electrical circuit to supply cables, for example in hostile mediums or on moving mechanisms. To overcome this problem, micromechanical devices converting vibrational energy into electrical power are known. These devices form microsystems that are generally adhesively bonded to vibrating supports, such as machines or vehicles. In a known technique, a resonant system is used to amplify the mechanical vibration of a support and to convert the amplified movement into electricity. The electrical circuit may thus be supplied with power without the need for cables coming from the outside.

One of the known principles for converting mechanical vibrational energy into electrical power is based on an electrostatic system. The electrostatic system uses a variable capacitor in order to convert the mechanical vibrational energy into electrical power.

Among these electrostatic systems, a first family comprises capacitors the plates of which are biased by sources of electrical power. The main problem encountered with this first family of electrostatic systems relates to the need to provide a source of electrical power that is available before energy conversion begins. On the one hand, such a source of electrical power complicates the electrical control structure of the electrostatic system. On the other hand, such a power source consumes some of the energy generated, thereby decreasing the overall efficiency of the energy conversion structure.

Because of these drawbacks, a second family of electrostatic systems has been developed. Such electrostatic systems are based on the use of electrets. An electret is a dielectric material having an almost permanent electrical polarization state. In contrast to a conventional capacitor the polarization of which is temporary (the charge stored finishes by disappearing by itself), an electret may keep its polarization for a very long time (for about several tens of years). In order to produce an electrostatic mechanical/electrical converter based on electrets, it is enough to place two electrodes facing each other and to create a relative movement between an electret and at least one of these two electrodes. The movement of the electret induces a variation of charge when the electrodes are located in a closed electrical circuit. Therefore an electrical current flows through a closed electrical circuit formed between the terminals of the electrodes when the system is subjected to vibrations.

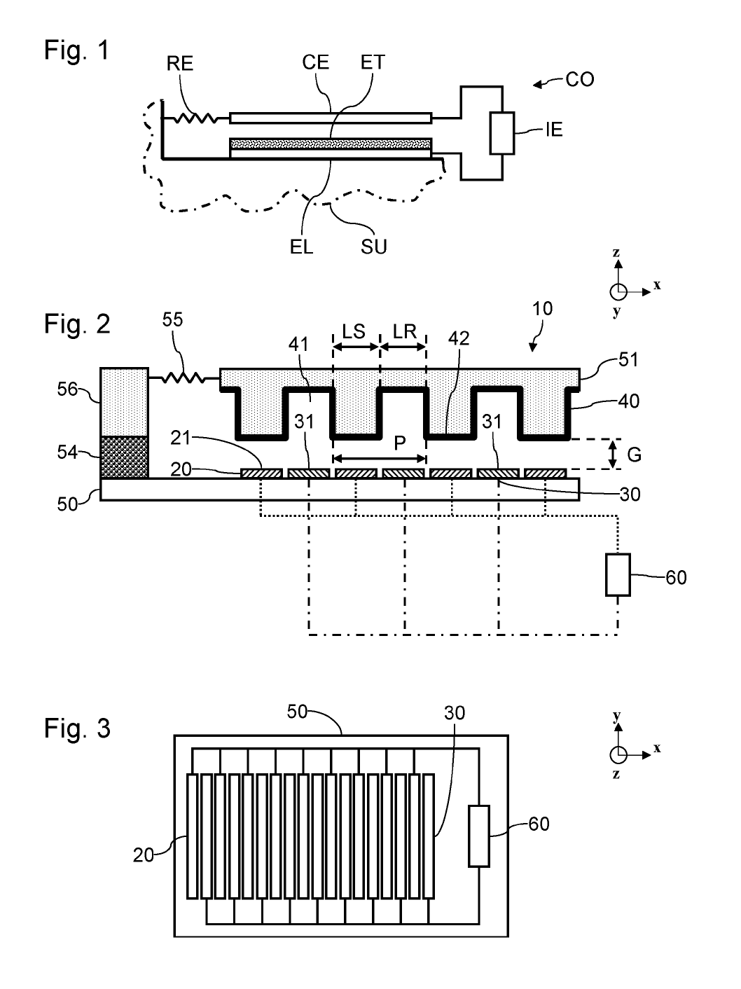

FIG. 1 is a schematic diagram of an example of a mechanical/electrical converter CO based on the use of an electret. As illustrated, the converter CO comprises an electrode EL and a counter electrode CE formed from metal plates connected by an electrical impedance IE. An electret ET forming a plate is fixed to the electrode EL. The electrode EL and the electret ET are both securely fastened to a support SU. The counter electrode CE is mounted so as to be able to move in its plane via a spring RE relative to the support SU.

By virtue of the vibrations of the medium, the counter electrode moves and the influence of the electret on this electrode varies. Because of the law of conservation of charge, the sum of the charges on the electrode and the counter electrode is equal to the charge on the electret, which is constant. Therefore, charge is redistributed between the electrode and the counter electrode. The voltages/currents that result therefrom thus allow the electrical impedance to be supplied with power.

A whole wafer electret with an area greater than one centimeter squared may store a relatively large charge (a few mC/m²) with a good stability (greater than 10 years). The stability is defined by the length of time the electret keeps its charge.

However, it has been shown that such a converter exhibits only a small variation in capacitance when it is subjected to small vibrational movements. Thus, the electrical power generated remains relatively small.

In order to increase the variation in the capacitance between two facing electrets under the effect of vibrations, the document “Electrostatic micro power generation from low-frequency vibration such as human motion” provides a fabrication process for forming electrets and electret absences in alternation in a direction parallel to a sliding direction. This document proposes to form electrets in succession with a relatively small pitch in order to increase the variation in capacitance during the vibrational movements. In this process, a planar layer of insulating silicon oxide is formed on a silicon substrate. An aluminum layer is deposited on the silicon oxide. The pattern of the electrets to be formed is then defined by etching the aluminum layer. Charge is then implanted locally in the silicon oxide layer in order to form the electrets. The residual aluminum is thus used as a mask to prevent charging of the zones that it covers.

The silicon substrate is mounted so as to be able to slide over a first glass sheet via a spring. A second glass sheet supports an alternation of electrodes with opposite polarities. The electrical impedance is connected between the electrodes of each polarity. The glass sheets are fastened to each other. The silicon support and its electrets are placed between the two glass sheets, facing the electrodes. The electrodes of a given polarity are distributed with a pitch identical to the distribution pitch of the electrets.

However, it has been observed that such electrets exhibit an unsatisfactory stability, in particular for relatively small distribution pitches (<300 μm). Such a lack of stability limits the usefulness of such converters, since reduction in the pitch between the electrets improves the conversion efficiency when the structure is subjected to small-amplitude vibrations.

The document “HARVESTING ENERGY FROM VIBRATIONS BY A MICROMACHINED ELECTRET GENERATOR” written by Messrs. Sterken, Fiorini, Altena, Van Hoof and Puers and published on the occasion of the 14th International Conference on Solid-State Sensors held in Lyon from 10 to 14 Jun. 2007, describes a structure intended to benefit from an electret having a high stability. This structure is also structured so as to generate large variations in capacitance during the movement, thereby in theory resulting in an improved conversion efficiency. Specifically, the structure comprises a silicon wafer fastened above a glass support. The glass support supports a first electrode comprising features distributed with a pitch. A movable mass is housed in the silicon wafer and slides horizontally above the glass support. The movable mass supports a second electrode comprising features distributed with the same pitch. The second electrode is placed opposite the first electrode. The electret, formed from a large continuous layer, polarizes the second electrode through the movable mass of silicon.

In practice, a constant parasitic capacitor is added in series between the electret and the movable mass, thereby greatly limiting the conversion efficiency of the structure.

Moreover, all of the electret-comprising mechanical/electrical converters developed up to now have remained confined to laboratory prototypes and have never been produced on an industrial scale.

The invention aims to solve one or more of these drawbacks. The invention thus relates to a device for converting mechanical vibrational energy into electrical power, comprising:
first and second collecting electrodes intended to be connected to the terminals of an electrical load;
an electret placed facing at least the first electrode, the electret being mounted so as to be able to move at least relative to the first electrode in at least one degree of freedom in a plane, so that a relative movement between the electret and the first electrode induces a potential difference across the first and second electrodes. In addition:
the electret comprises a continuous layer containing a series of protrusions extending in a direction perpendicular to said plane, the protrusions being distributed in said degree of freedom with a pitch smaller than the travel between the first electrode and the electret; and
the first electrode has faces facing the electret, these faces being distributed in said degree of freedom with a pitch identical to the pitch of the protrusions of the electret.

According to one variant, the first and second electrodes are housed on the same support facing the electret, the second electrode having faces distributed in said degree of freedom with a pitch identical to the pitch of the protrusions of the electret, the faces of the first and second electrodes being alternated.

According to another variant, the first and second electrodes are housed on respective supports placed on either side of the electret.

According to another variant, the electret is mounted so as to be able to slide relative to the first electrode in a direction contained in said plane, the protrusions being distributed in said plane in this sliding direction, the faces of the first electrode being distributed in this sliding direction.

According to yet another variant, the faces of the first electrode are separated by grooves having a width greater than the width of the faces.

According to one variant, the pitch of the protrusions is smaller than 200 μm, and preferably smaller than 100 μm.

According to another variant, the electret is mounted so as to be able to pivot relative to the first electrode about an axis normal to said plane, the protrusions being angularly distributed about this axis, the faces of the first electrode being angularly distributed about this axis.

According to another variant, the protrusions of the electret are separated by grooves having a depth between 10 μm and 500 μm.

According to another variant, the electret is separated from the first electrode by a distance smaller than 10 μm, and preferably smaller than 5 μm.

According to another variant, the pitch of the protrusions of the electret is at least 20 times larger than said distance.

According to one variant, the electret is housed on a support containing a relief pattern, the electret being formed from a dielectric layer of continuous thickness.

According to another variant, the electret is covered with a continuous protective layer.

According to another variant, the electret is formed from a layer of silicon oxide housed on a silicon substrate.

According to yet another variant, the electret is connected to the first electrode via a spring compressed by a relative movement in said degree of freedom between the first electrode and the electret.

The invention also relates to a process for fabricating a device for converting mechanical energy into electrical power, comprising steps of:
forming a continuous layer of dielectric containing a series of protrusions extending in a direction and distributed with a pitch;
charging the continuous layer of dielectric formed so as to form an electret; and
assembling the electret facing first and second collecting electrodes, the electret being mounted so as to be able to move relative to the first electrode in a degree of freedom in a plane perpendicular to said direction with a travel in this degree of freedom larger than the pitch of the protrusions, so that a relative movement between the electret and the first electrode induces a potential difference across the first and second electrodes, the first electrode having faces facing the electret, which faces are distributed in said degree of freedom with a pitch identical to the pitch of the protrusions of the electret.

According to one variant, the formation of the continuous layer of dielectric comprises:
etching a face of a support made of silicon in order to form protrusions with said pitch in a direction of a relative sliding motion between the electret and the first electrode; and
forming a continuous layer of dielectric on the etched face of the support.

According to yet another variant, the continuous layer of dielectric is formed by oxidizing the etched face of the silicon oxide support.

Other features and advantages of the invention will become clear from the completely non-limiting description given thereof below by way of indication, with reference the appended drawings, in which:

FIG. 1 schematically illustrates an example of an electret-comprising mechanical/electrical converter;

FIG. 2 is a cross-sectional view of an electret-comprising electrical/mechanical conversion structure according to a first embodiment of the invention;

FIG. 3 is a schematic top view of the configuration of the electrodes in this first embodiment;

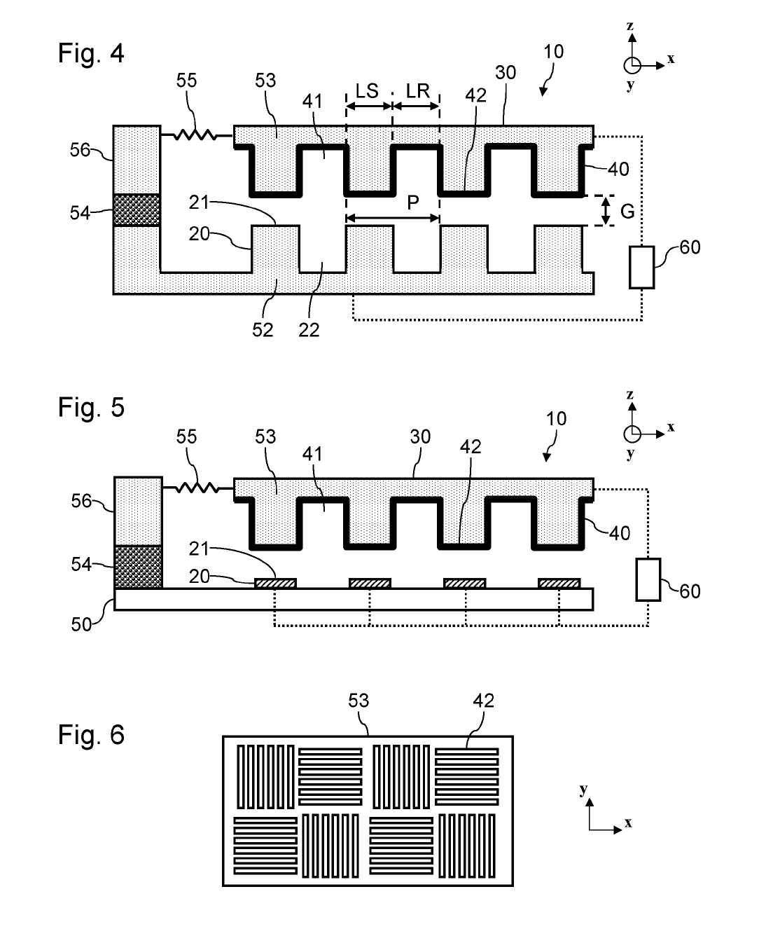

FIG. 4 is a cross-sectional view of an electret-comprising electrical/mechanical conversion structure according to a second embodiment of the invention;

FIG. 5 is a cross-sectional view of an electret-comprising electrical/mechanical conversion structure according to a third embodiment of the invention;

FIG. 6 is a bottom view of an example of a combination of electret patterns allowing exploitation of vibrational excitation along separate axes;

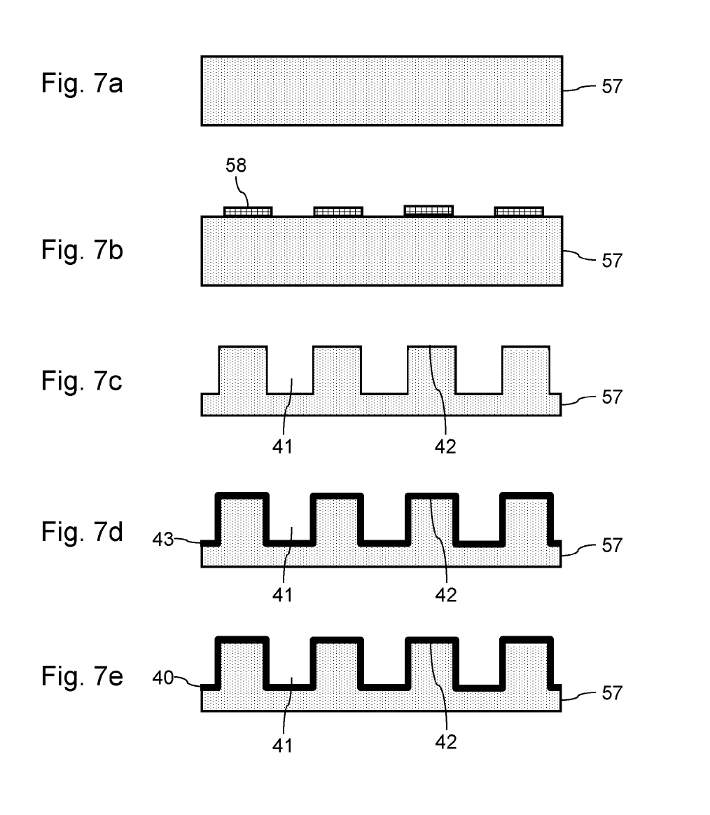

FIGS. 7a to 7e illustrate various steps in a first variant process for fabricating an electret for producing a conversion structure according to the invention;

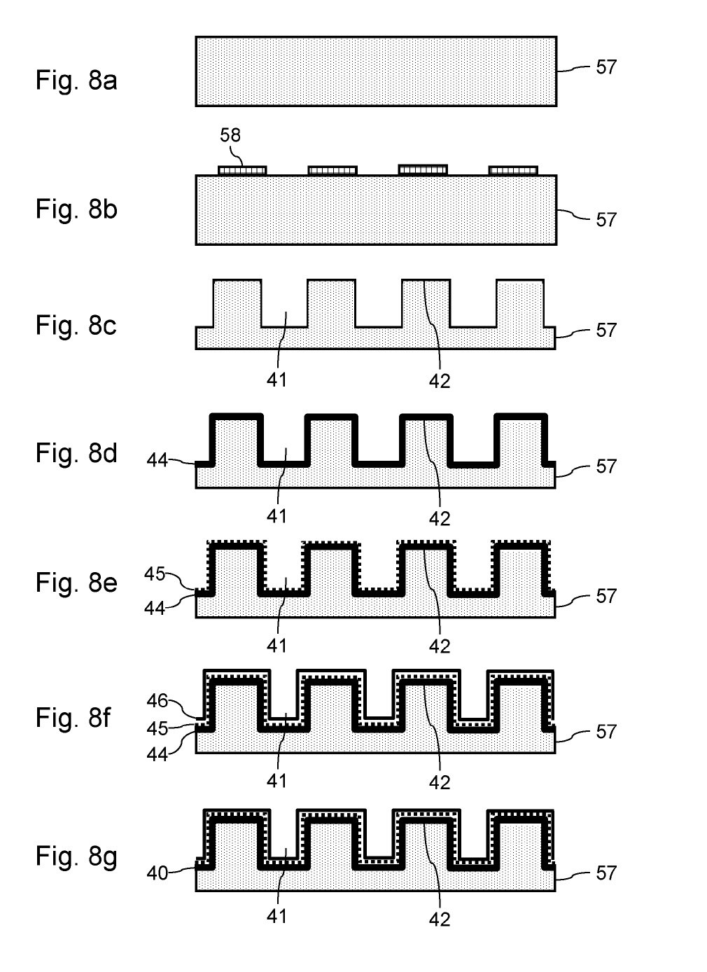

FIGS. 8a to 8g illustrate various steps in a second variant process for fabricating an electret for producing a conversion structure according to the invention;

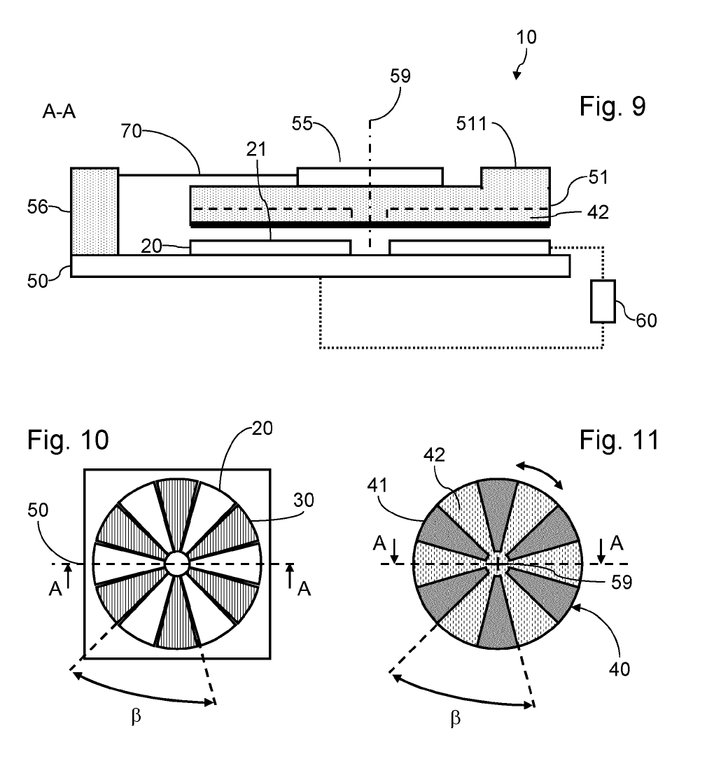

FIG. 9 is a cross-sectional side view of an electret-comprising electrical/mechanical conversion structure according to a fourth embodiment of the invention;

FIGS. 10 and 11 are respectively top and bottom views of a pair of electrodes and an electret of the structure in FIG. 9;

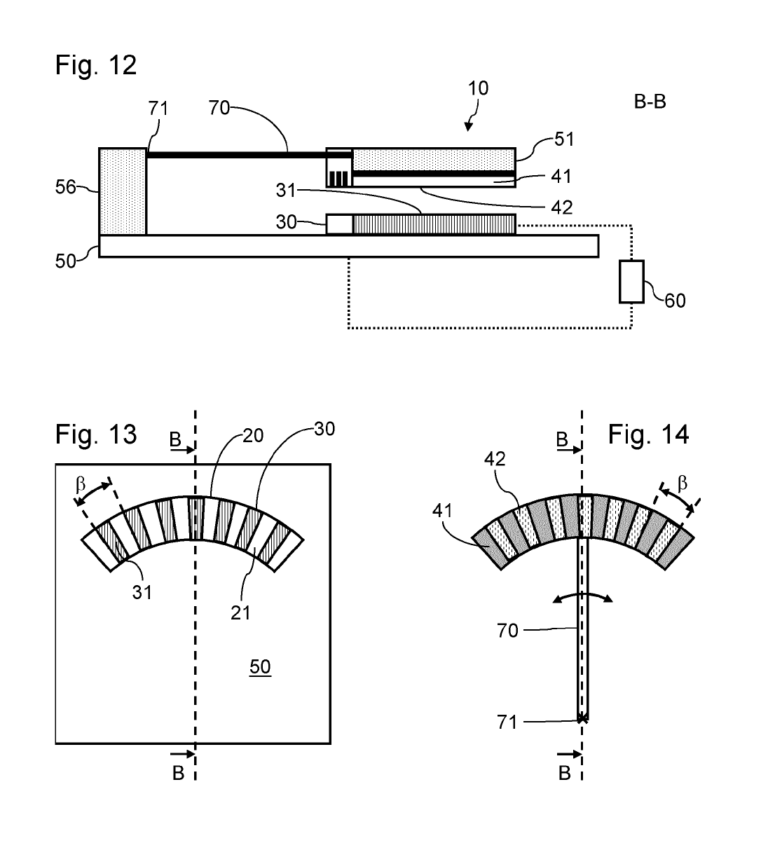

FIG. 12 is a cross-sectional side view of an electret-comprising electrical/mechanical conversion structure according to a fifth embodiment of the invention; and

FIGS. 13 and 14 are respectively top and bottom views of a pair of electrodes and an electret of the structure in FIG. 12.

The invention makes it possible to exploit electrets having very high stabilities and allowing large variations in capacitance to be generated with small movements. The amount of electrical power that can be generated using a conversion device of a given size may be substantially increased. A large variation in capacitance per unit of relative movement of the electret can be obtained because of the permitted fineness of the electret structure. Moreover, this structural fineness means a large range of vibrational amplitudes can be exploited. Whereas conventional technical best practice would suggest it makes sense to form a discontinuous electret, this electret only being formed on the protrusions (the presence of electret in the grooves in theory decreasing the variation in capacitance during the movement of a movable mass), the inventors have in fact demonstrated that a continuous electret with protrusions is particularly advantageous.

The embodiments illustrated with reference to FIGS. 2 to 6 relate to devices for converting vibrational energy in which an electret is mounted so as to be able to slide relative to a facing electrode. The electret slides in a plane, and comprises protrusions extending perpendicularly to this plane.

FIG. 2 is a cross-sectional view of a first embodiment of a structure 10 for converting mechanical vibrational energy into electrical power. The structure 10 comprises a support 50 intended to be securely fastened to the system generating the vibrational energy. A silicon-based structure is fastened plumb with the support 50 using a resin 54. The silicon-based structure comprises a fixed frame 56 and a movable support 51. The movable support 51 is connected to the fixed frame 56 via a spring 55. The movable support 51 is mounted so as to be able to slide relative to the support 50 in the x direction. The support 51 compresses the spring 55 during its movements along this x axis. The spring 55 may be produced by processing of the silicon-based structure.

The support 50 is made of a dielectric, for example glass. The support 50 comprises a first electrode 20 and a second electrode 30 on its upper surface. The electrodes 20 and 30 are formed of metal strips extending in the y direction. The metal strips forming the electrode 20 comprise faces 21 oriented upward. The metal strips forming the electrode 30 comprise faces 31 oriented upward. The metal strips of the electrode 20 are isolated from the metal strips of the electrode 30. The faces 21 are distributed in the x direction with a pitch P. The faces 31 are also distributed in the x direction with a pitch P. The faces 21 are separated from each other by the faces 31. The faces 21 and 31 therefore alternate in the x direction.

FIG. 3 is a top view of the configuration of the electrodes 20 and 30 on the support 50. The electrode 20 and the electrode 30 are connected to respective terminals of an electrical load 60. The electrical load 60 may be an electronic circuit, for example including a recharging circuit including a capacitor for storing energy and a functional circuit powered by this capacitor. The metal strips forming the electrode 20 are all connected to a first terminal of the electrical load 60. The metal strips forming the electrode 30 are connected to a second terminal of the electrical load 60. In this embodiment, the electrode 20, the electrode 30 and the electrical load 60 are fixed to the same support 50, thereby making their fabrication easier.

An electret 40 is housed on the lower face of the movable support 51. The electret 40 comprises a continuous layer of dielectric material storing charge. The dielectric layer of the electret 40 closely follows the relief pattern in the movable support 51 in order to form a series of protrusions 42 separated by grooves 41. The electret 40 may especially comprise a layer of SiO₂ or a layer of a polymer such as parylene. The electret 40 is advantageously formed from a uniform material layer. The protrusions 42 extend in the z direction. The protrusions 42 are distributed in the x direction with a pitch P identical to the pitch of the metal strips of the electrodes 20 and 30. The protrusions 42 and the grooves 41 extend in the y direction. The electret 40 is placed facing faces 21 and 31 of the first and second electrodes 20 and 30, respectively. The movable support 51 has a travel in the x direction larger than the distribution pitch P of the protrusions 42. The assembly formed by the movable support 51, the electret 40 and the spring 55 has a resonant frequency centered on a frequency range for vibrations for which an optimal conversion gain is sought.

When a vibration pushes the movable support 51 and the electret 40 in the x direction (i.e. generates a relative movement between the support 50 and the support 51), transfers of electrical charge are induced between the electrodes 20 and 30. Due to these charge transfers, a potential difference appears across the terminals of the electrical load 60 and an electrical current flows through this electrical load 60.

When the relative movement of the electret 40 is larger than the pitch P several electrical alternations are generated during the travel. With an open electrical circuit, the polarity of the potential difference changes when the electret slides a distance equal to half the pitch P. The amount of electrical power recovered when the electret travels its entire travel is thus maximized. Moreover, efficient electrical power conversion is obtained even when the amplitude of the sliding motion of the electret 40 varies greatly over time, several alternations being generated even with a limited sliding motion. The frequency of the potential difference generated across the terminals of the load 60 may be higher than the resonant frequency of the resonant system or of the vibration frequency of the source of vibrations. This performance is obtained while benefiting from a stable electret 40 because a continuous dielectric layer is used.

The invention proves to be particularly advantageous when the gap or distance G between the electret 40 and the electrode 20 is relatively small, for example when this gap G is smaller than 10 μm, even smaller than 5 μm. Specifically, the inventors have observed that edge effects may be particularly appreciable at such dimensions, further increasing the conversion gain.

In order to limit the impact of such edge effects, the pitch P of the protrusions 42 is advantageously at least 20 times larger than this gap G. If LS denotes the width of the protrusions 42 and LR the width of the grooves 41, it proves to be advantageous for the following relationships to be respected:

LR>10·G

LS>10·G

FIG. 4 is a cross-sectional view of a second embodiment of a structure 10 for converting mechanical vibrational energy into electrical power. The structure 10 comprises a support 52 intended to be securely fastened to the system generating the vibrational energy. The support 52 is made of a semiconductor, for example from a silicon wafer.

A semiconductor-based structure (silicon wafer) is fixed plumb with the support 52 using a resin 54. The silicon-based structure comprises a fixed frame 56 and a movable support 53. The movable support 53 is connected to the fixed frame 56 via a spring 55. The movable support 53 is mounted so as to be able to slide relative to the support 52 in the x direction. The support 53 compresses the spring 55 during its movements along this X axis. The spring 55 may be produced by processing of a silicon wafer in which the fixed frame 56 and the movable support 53 are formed.

The support 53 contains, in the z direction, a relief pattern formed by alternating protrusions and grooves. The protrusions and the grooves in the support 53 extend in the y direction. The protrusions and grooves in the support 53 are distributed in the x direction with a pitch P. The support 52 also contains, in the z direction, a relief pattern formed by alternating grooves 22 and protrusions. The protrusions and the grooves in the support 52 extend in the y direction. The protrusions and the grooves in the support 52 are distributed in the x direction with a pitch P. The relief patterns in the supports 52 and 53 are placed facing each other.

The electret 40 comprises a continuous layer covering the protrusions and the grooves in the support 53. The electret 40 may especially comprise a layer of SiO₂ or a layer of a polymer such as parylene. The electret 40 closely follows the relief pattern in the support 53 and thus exhibits an alternation of protrusions 42 and grooves 41 distributed in the x direction with the pitch P. The pitch P is smaller than the travel of the support 53 and of the electret 40 in the x direction. The protrusions 42 and the grooves 41 extend in the y direction. The electret 40 is advantageously made from a dielectric layer of continuous thickness formed on the support 53 containing the relief pattern.

The support 52 forms the first electrode 20 by having faces 21 at the ends of its protrusions and by being sufficiently conductive to conduct electric charge to and from these faces 21. The support 53 forms the second electrode 30 by being sufficiently conductive to conduct the charge to and from its protrusions. The electrodes 20 and 30 are thus formed in supports placed on either side of the electret 40. The electrical load 60 is connected between the support 52 and the support 53.

When the protrusions 42 lie opposite the faces 21, the capacitance of the capacitor formed is maximized and corresponds to the sum of the capacitances C1 between protrusions 42 and faces 21 and of the capacitances C2 between the grooves 41 and the grooves 22. The capacitance Cmax of the capacitor formed is given by the following relationship:

$$\begin{matrix}{C}_{max} = {nC}_{1} + ( n - 1 ) {C}_{2} \\ = n \frac{{ɛ}_{0} * LS * LO}{G + \frac{EP}{ɛ}} + ( n - 1 ) \frac{{ɛ}_{0} * LS * LO}{2 DE + G + \frac{EP}{ɛ}}\end{matrix}$$

where n is the number of protrusions, EP is the thickness of the electret, c is the permittivity of the electret, LO is the length of the protrusions 42 and of the faces 21, DE is the depth of the grooves 41 and of the grooves 22, and LS is the width of the protrusions 42 and the faces 21.

When the protrusions 42 lie opposite the grooves 22, the capacitance of the capacitor formed is minimized and corresponds to the sum of the capacitances C3 between protrusions 42 and grooves 22 and of the capacitances C4 between the grooves 41 and the faces 21. The capacitance Cmin of the capacitor formed is given by the following relationship:

$$\begin{matrix}{C}_{min} = {nC}_{3} + ( n - 1 ) {C}_{4} \\ = ( 2 n - 1 ) \frac{{ɛ}_{0} * LS * LO}{DE + G + \frac{EP}{ɛ}}\end{matrix}$$

For a high value of n and for DE>>G, the ratio between Cmax and C min may then be expressed as follows:

$$\frac{{C}_{max}}{{C}_{min}} ≅ \frac{3}{4} + \frac{DS}{2 ( G + \frac{EP}{ɛ} )}$$

The proposed structure thus allows the variations in capacitance per unit sliding movement of the electret 40 to be optimized and the conversion gain of the converter 10 to be increased.

In order to promote optimal capacitance variation between the electret 40 and electrode 20 during their relative movement, the grooves 41 separating the protrusions 42 of the electret 40 advantageously have a depth (relief in the z direction) of between 10 and 500 μm.

The inventors have furthermore observed that using a continuous layer to form the electret 40 allows edge effects to be limited for small protrusions 42, for example when their pitch P is smaller than 200 μm, and in particular when their pitch P is smaller than 100 μm.

Advantageously, the grooves in the support 53 are wider than the protrusions in the same support 53. Likewise, the grooves in the support 52 are wider than the protrusions in the same support 52.

FIG. 5 is a cross-sectional view of a third embodiment of a structure 10 for converting mechanical vibrational energy into electrical power. The structure 10 comprises a support 50 intended to be securely fastened to the system generating the vibrational energy. The support 50 is made of an insulator, for example from a glass sheet.

A semiconductor-based structure (silicon wafer) is fixed plumb with the support 50 using a resin 54. The silicon-based structure comprises a fixed frame 56 and a movable support 53. The movable support 53 is connected to the fixed frame 56 via a spring 55. The movable support 53 is mounted so as to be able to slide relative to the support 50 along this X axis. The support 53 compresses the spring 55 during its movements along this X axis. The spring 55 may be produced by processing of a silicon wafer in which the fixed frame 56 and the movable support 53 are formed.

The support 53 contains, in the z direction, a relief pattern formed by alternating protrusions and grooves. The protrusions and the grooves in the support 53 extend in the y direction. The protrusions and grooves in the support 53 are distributed in the x direction with a pitch P.

The support 50 comprises a substantially flat upper face on which a first electrode 20 is housed. The electrode 20 is advantageously housed in relief on the support 50 in order to increase the variation in capacitance during the sliding movement of the electret 40. The electrode 20 is formed from metal strips extending in the y direction. The metal strips forming the electrode 20 comprise faces 21 pointed upward. The faces 21 are distributed in the x direction with a pitch P.

The electret 40 comprises a continuous layer covering the protrusions and the grooves of the support 53. The electret 40 may especially comprise a layer of SiO₂ or a layer of a polymer such as parylene. The electret 40 closely follows the relief pattern in the support 53 and thus exhibits an alternation of protrusions 42 and grooves 41 distributed in the x direction with a pitch P. The pitch P is smaller than the travel of the support 53 and of the electret 40 in the x direction. The protrusions 42 and the grooves 41 extend in the y direction. The electret 40 is advantageously made from a dielectric layer of continuous thickness formed on the support 53 containing the relief pattern. The electret 40 is opposite the electrode 20.

The support 53 forms of the second electrode 30 by being sufficiently conductive to conduct the charge to and from its protrusions. The electrodes 20 and 30 are thus formed on supports placed on either side of the electret 40. The electrical load 60 is connected between the electrode 20 and the electrode 30.

The electrodes 20 and 30 of the supports 51, 52 and 53 of the embodiments described above may also be formed by a conductive layer that closely follows the relief patterns formed therein. The electrode 30 housed on a support 51 or 53 may for example be formed from a conductive metal layer placed between the silicon of the support and the electret 40.

FIG. 6 is a bottom view of a support 53 comprising two groups of electrets 40. The electrets of a first group contain protrusions 42 distributed in the y direction. The electrets of a second group contain protrusions 42 distributed in the x direction. The electrets 40 are plumb with electrodes 20 and 30 containing corresponding distributions. The support 53 is mounted so as to be able to slide in the x and y directions relative to the electrode 20. Thus, the converter 10 is capable of making optimal use of vibrations having various orientations or having orientations that vary over time.

Various electrets having different respective distribution pitches may also be provided. Furthermore, various electrets having different phase shifts relative to the electrodes 20 placed opposite may be provided.

FIGS. 7a to 7e schematically illustrate a first variant of a process for fabricating an electret 40 on a support 57 made of silicon. For the sake of simplicity, certain optional steps of this process, such as the production of a spring connecting the support or the electret assembly formed in a conversion device, are not described.

In FIG. 7a, a silicon wafer 57 having two substantially flat sides is provided. As illustrated in FIG. 7b, a resist is then deposited. Using a photolithography process known per se, a pattern 58 of hardened resist is formed on one side of the silicon wafer.

As illustrated in FIG. 7c, a relief pattern is formed in the silicon wafer 57 by an etching step, using the pattern 58. Etching processes known per se in the art may be used. Wet etching processes (such as KOH etching) or dry etching processes (such as DRIE etching) may be employed. In the context of the invention, DRIE etching is advantageously used, thereby allowing protrusions to be produced with very straight sidewalls, even for groove depths exceeding 100 μm. After the resist has been removed, the etching may be followed by a heat treatment. The relief pattern formed thus contains protrusions and grooves in alternation, housed in the silicon wafer 57.

As illustrated in FIG. 7d, a dielectric film 43 is formed on the relief pattern in the silicon wafer 57. In this case, the film 43 has a uniform thickness and closely follows the relief pattern in the wafer 57. The film 43 thus exhibits an alternation of protrusions 42 and grooves 41. The film 43 is for example made of a polymer such as parylene. This material promotes the stability of the electret to be formed since it is hydrophobic and thus limits charge loss due to moisture. This material furthermore has a good capacity for storing electrical charge permanently. The film 43 may for example be between 10 nm and 9 μm in thickness.

As illustrated in FIG. 7e, charge is then implanted in the film 43 in order to form a continuous electret 40. The implantation of charge in order to form the electret 40 may be carried out in any appropriate way. The charge may especially be implanted using what is called a corona discharge technique. A corona discharge is an electrical discharge that appears when the electric field on a conductor exceeds a certain value, under conditions that prevent an electric arc from striking. The medium surrounding the electrical conductor is then ionized and a plasma is created. The ions generated transfer their charge to the surrounding molecules with the lowest energy. The charge will advantageously be implanted using a triode corona discharge process in which a metal grid is used to control the surface potential and homogenize the charge in the electret. The charging step will possibly be followed by a heat treatment.

FIGS. 8a to 8g schematically illustrate a second variant of a process for manufacturing an electret 40 on a support 57 made of silicon.

In FIG. 8a, a silicon wafer 57 having two substantially flat sides is provided. As illustrated in FIG. 8b, a resist is then deposited. Using a photolithography process known per se, a pattern 58 of hardened resist is formed on one side of the silicon wafer 57.

As illustrated in FIG. 8c, a relief pattern is formed in the silicon wafer 57 by an etching step, using the pattern 58. Etching processes known per se in the art may be used. The relief pattern formed thus contains protrusions and grooves in alternation, housed in the silicon wafer 57. The resist is then removed.

As illustrated in FIG. 8d, a dielectric layer 44 is formed on the relief pattern in the silicon wafer 57. The layer 44 is an SiO₂ layer for example created by thermal oxidation of the side of the wafer 57 containing the relief pattern. The layer 44 thus exhibits an alternation of protrusions 42 and grooves 41. The layer 44 may for example be formed with a thickness of between 50 nm and 5 μm.

As illustrated in FIG. 8e, a layer 45 of a stabilizing material is advantageously formed on the layer 44. The layer 45 is for example made of silicon nitride Si₃N₄. Such a layer 45 allows the stability of the electret formed to be improved by trapping the charge. The layer 45 may be produced by low-pressure chemical vapor deposition (LPCVD). The layer 45 may for example be between 50 and 500 nm in thickness. Deposition of the layer 45 may be followed by a heat treatment step, typically at a temperature above 400° C. for several hours.

As illustrated in FIG. 8f, a protective layer 46 may be deposited. The aim of the protective layer 46 is to prevent contact between moisture and the electret formed, in order to prevent loss of the charge stored in the dielectric. The protective layer 46 may typically be made of parylene or HMDS, which have good hydrophobic properties. The layer 46 may for example be between 10 nm and 10 μm in thickness.

As illustrated in FIG. 8g, charge is then implanted in the film 44 in order to form a continuous electret 40. The charge used to form the electret 40 may be implanted in any appropriate way. The charge may for example be implanted using a corona discharge technique.

Other processes for forming a continuous electret may of course be envisioned. It is especially possible to deposit a dielectric on a support by sputtering.

The embodiments illustrated with reference to FIGS. 9 to 14 relate to vibrational energy conversion devices in which an electret is mounted so as to be able to pivot relative to a facing electrode. The electret pivots in a plane, and contains protrusions extending perpendicularly to this plane.

FIG. 9 is a cross-sectional view of a fourth embodiment of a structure for converting mechanical vibrational energy into electrical power. The structure 10 comprises a support 50 intended to be securely fastened to the system generating the vibrational energy. A silicon-based structure is fastened plumb with the support 50. The silicon-based structure comprises a fixed frame 56 and a movable support 51. The movable support 51 is connected to the fixed frame 56 via a torsion spring 55 and a rigid beam 70. The movable support 51 is mounted so as to be able to pivot about a vertical axis 59 (z direction) relative to the fixed frame 56. An eccentric mass 511 is fixed to the movable support 51. The mass 511 is eccentric relative to the axis 59. Because the assembly formed by the mass 511 and the movable support 51 is unbalanced relative to the axis 59, a relative movement between the movable mass 51 and the support 50 generates a rotation of the movable mass 51 relative to the support 50. The support 51 thus compresses the spring 55 when it is subjected to a vibration, due to the presence of the eccentric mass 511.

FIG. 10 is a top view of the support 50 supporting the electrodes. FIG. 11 is a bottom view of the support 51 supporting an electret 40.

The support 50 is made of a dielectric, for example of glass. The support 50 comprises a first electrode 20 and a second electrode 30 on its upper side. The electrodes 20 and 30 are formed from angular segments distributed about a geometric centre. The angular segments forming the electrode 20 comprise faces 21 oriented upward. The angular segments forming the electrode 30 also comprise faces that are oriented upward. The angular segments of the electrode 20 are isolated from the angular segments of the electrode 30. The faces 21 of the electrode 20 are distributed about the geometric centre with an angular pitch β. The faces of the electrode 30 are distributed about the geometric centre with an angular pitch β. The respective faces of the electrodes 20 and 30 are alternated about the geometric centre. The electrode 20 and the electrode 30 are connected to respective terminals of an electrical load 60. The angular segments forming the electrode 20 are all connected to a first terminal of the electrical load 60. The angular segments forming the electrode 30 are connected to a second terminal of the electrical load 60. In this embodiment, the electrode 20, the electrode 30 and the electrical load 60 are fixed to the same support 50, thereby making their fabrication easier.

The electret 40 is housed on the lower side of the movable support 51. The electret 40 comprises a continuous dielectric layer storing charge. The dielectric layer of the electret 40 closely follows the relief pattern in the movable support 51 thus forming a series of protrusions 42 taking the shape of angular segments, separated by grooves 41 also taking the shape of angular segments. The protrusions 42 extend in the z direction relative to a plane in which the support 51 pivots. The protrusions 42 are distributed about the axis 59 with an angular pitch β identical to the angular pitch of the angular segments of the electrodes 20 and 30. The electret 40 is placed facing the faces of the first and second electrodes 20 and 30. The movable support 51 exhibits a pivotal travel about the axis 59, which travel is larger than the angular pitch β of the distribution of the protrusions 42. When a vibration drives the movable support 51 with a rotational component about the axis 59, the movable support 51 pivots relative to the support 50. Electrical charge is then induced to move back and forth between the electrodes 20 and 30. Because of this movement of charge, a potential difference appears across the terminals of the electrical load 60 and an electrical current flows through this electrical load 60.

When the relative movement of the electret 40 is larger than the angular pitch β between the protrusions 42, a number of electrical alternations are generated during the travel. For an open electrical circuit, the polarity of the potential different changes when the electret slides a distance equal to half the angular pitch β between the protrusions 42. The amount of electrical power recovered when the electret travels its entire travel is thus maximized.

FIG. 12 is a cross-sectional view of a fifth embodiment of a structure for converting mechanical vibrational energy into electrical power. The structure 10 comprises a support 50 intended to be securely fastened to the system generating the vibrational energy. A silicon-based structure is fastened plumb with the support 50. The silicon-based structure comprises a fixed frame 56 and a movable support 51. The movable support 51 is connected to the fixed frame 56 via a beam 70. The beam 70 has an end embedded in the fixed frame 56 and another end embedded in the support 51. The beam 70 has dimensions that allow it to flex about a vertical axis (z direction) when it is subjected to vibrations, under the effect of the inertia of the movable support 51. The movable support 51 thus pivots about a vertical axis passing through the point 71 where the beam 70 joins the fixed frame 56.

FIG. 13 is a top view of the electrode-supporting support 50. FIG. 14 is a bottom view of the support 51 supporting an electret 40.

The support 50 is made of a dielectric. The support 50 comprises a first electrode 20 and a second electrode 30 on its upper side. The electrodes 20 and 30 are formed from angular segments of a ring having the junction point 71 as its geometric centre. The geometric centre is placed substantially on the axis about which the movable support 51 pivots. The angular segments forming the electrode 20 comprise faces 21 oriented upward. The angular segments forming the electrode 30 comprise faces 31 also oriented upward. The angular segments of the electrode 20 are isolated from the angular segments of the electrode 30. The faces 21 of the electrode 20 are distributed with an angular pitch β over an arc of a circle having the junction point 71 as its geometric centre. The faces 31 of the electrode 30 are distributed with an angular pitch β over an arc of a circle having the junction point 71 as its geometric centre. The respective faces of the electrodes 20 and 30 are alternated about the geometric centre. The electrode 20 and the electrode 30 are connected to respective terminals of an electrical load 60. The angular segments forming the electrode 20 are all connected to a first terminal of the electrical load 60. The angular segments forming the electrode 30 are connected to a second terminal of the electrical load 60. In this embodiment, the electrode 20, the electrode 30 and the electrical load 60 are fixed to the same support 50, thereby making their fabrication easier.

The electret 40 is housed on the lower side of the movable support 51. The electret 40 comprises a continuous dielectric layer storing charge. The dielectric layer of the electret 40 closely follows the relief pattern in the movable support 51 thus forming a series of protrusions 42 taking the shape of angular segments of a ring, separated by grooves 41 also taking the shape of angular segments of a ring. The protrusions 42 extend in the z direction relative to a plane in which the support 51 pivots. The protrusions 42 are distributed over an arc of a circle, having the junction point 71 as its geometric center, with an angular pitch β identical to the angular pitch of the angular segments of the electrodes 20 and 30. The electret 40 is placed facing the faces of the first and second electrodes 20 and 30. The movable support 51 exhibits a pivotal travel about the junction point, which travel is larger than the angular pitch of the distribution of the protrusions 42. When a vibration drives the movable support 51 with a rotational component about the junction point 71, the movable support 51 pivots relative to the support 50. Electrical charge is then induced to move back and forth between the electrodes 20 and 30. Because of this movement of charge, a potential difference appears across the terminals of the electrical load 60 and an electrical current flows through this electrical load 60.

When the relative movement of the electret 40 is larger than the angular pitch β between the protrusions 42, a number of electrical alternations are generated during the travel. For an open electrical circuit, the polarity of the potential different changes when the electret slides a distance equal to half the angular pitch β between the protrusions 42. The amount of electrical power recovered when the electret travels its entire travel is thus maximized.

1-17. (canceled)

18. An apparatus for converting mechanical vibrational energy into electrical power, said apparatus comprising first and second collecting electrodes configured for connection to terminals of an electrical load, an electret placed facing at least said first electrode, said electret being mounted so as to be able to move at least relative to said first electrode along at least one degree-of-freedom in a plane, whereby relative movement between said electret and said first electrode induces a potential difference across said first and second electrodes, said electret comprising a continuous layer having a series of protrusions extending in a direction perpendicular to said plane, said protrusions being distributed along said degree-of-freedom with a first pitch, said first pitch being smaller than an extent of travel between said first electrode and said electret, and wherein said first electrode comprises faces facing said electret, said faces being distributed in said degree-of-freedom with a second pitch, said second pitch being identical to said first pitch.

19. The apparatus of claim 18, wherein said first and second electrodes are housed in a common support facing said electret, wherein said second electrode comprises faces distributed along said degree-of-freedom with a pitch identical to said first pitch, said faces of said first and second electrodes being alternated.

20. The apparatus of claim 18, wherein said first and second electrodes are housed on respective supports placed on either side of said electret.

21. The apparatus of claim 18, wherein said electret is mounted so as to be able to slide relative to said first electrode in a direction contained in said plane, said protrusions being distributed in said plane along said sliding direction, said faces of said first electrode being distributed along said sliding direction.

22. The apparatus of claim 21, wherein said faces of said first electrode are separated by grooves having a width greater than a width of said faces.

23. The apparatus of claim 21, wherein said first pitch is smaller than 200 μm.

24. The apparatus of claim 21, wherein said first pitch is smaller than 100 μm.

25. The apparatus of claim 18, wherein said electret is mounted so as to be able to pivot relative to said first electrode about an axis normal to said plane, and wherein said protrusions are angularly distributed about said axis, said faces of said first electrode being angularly distributed about said axis.

26. The apparatus of claim 18, wherein said protrusions are separated by grooves having a depth between 10 μm and 500 μm.

27. The apparatus of claim 18, wherein said electret is separated from said first electrode by a distance smaller than 10 μm.

28. The apparatus of claim 18, wherein said electret is separated from said first electrode by a distance smaller than 5 p.m.

29. The apparatus of claim 18, wherein said electret is separated from said first electrode by a distance, and wherein said first pitch is at least twenty times larger than said distance.

30. The apparatus of claim 18, wherein said electret is housed on a support containing a relief pattern, and wherein said electret is formed from a dielectric layer of continuous thickness.

31. The apparatus of claim 18, wherein said electret is covered with a continuous protective layer.

32. The apparatus of claim 18, wherein said electret is formed from a layer of silicon oxide housed on a silicon substrate.

33. The apparatus of claim 18, further comprising a spring connecting said electret to said first electrode, said spring being disposed to be compressed by a relative movement along said degree-of-freedom between said first electrode and said electret.

34. A process for fabricating an apparatus for converting mechanical energy into electrical power, said process comprising forming a continuous layer of dielectric containing a series of protrusions extending along a direction and distributed with a first pitch, forming an electret by charging said continuous layer of dielectric, and assembling said electret into a position facing first and second collecting electrodes, said electret being mounted so as to be able to move relative to said first electrode along a degree-of-freedom in a plane perpendicular to said direction with a travel along said degree-of-freedom larger than said first pitch, whereby relative movement between said electret and said first electrode induces a potential difference across said first and second electrodes, said first electrode having faces facing said electret, said faces being distributed along said degree-of-freedom with a second pitch identical to said first pitch.

35. The process of claim 34, wherein forming said continuous layer of dielectric comprises etching a face of a support comprising silicon in order to form protrusions with said first pitch in a direction of a relative sliding motion between said electret and said first electrode, and forming a continuous layer of dielectric on said etched face of said support.

36. The process of claim 35, wherein forming said continuous layer of dielectric further comprises oxidizing said etched face of said silicon oxide support.
